(19) United States
(12) Patent Application Publication
(10) Pub. No.: US 2013/0062339 A1
(43) Pub. Date: Mar. 14, 2013

(54) PIPE REMOVAL TOOL AND METHOD

(71) Applicant: Carmen T. DeRosa, West Haven, CT (US)

(72) Inventor: Carmen T. DeRosa, West Haven, CT (US)

(21) Appl. No.: 13/227,994

(22) Filed: Sep. 8, 2011

(51) Int. Cl. H05B 6/02; B23K 11/00

(52) U.S. Cl. 219/600; 219/108; 219/117.1

(57) ABSTRACT

A tool to supply heat to a PEX pipe to permit the PEX pipe to be removed from a fitting connection includes a thermal element that can supply heat to the PEX pipe. The thermal element may be heated via electrical processes, such as resistive or inductive heating, or may be heated with a combustion process. The thermal element may be implemented in a pliers to permit the heating element to be placed around the PEX pipe and clamped, to allow the user to pull the PEX pipe off the fitting connection using the pliers. The tool may have a temperature control to regulate an amount of heat provided to the PEX pipe during removal, which control may include a feedback transducer, such as a thermocouple. The tool may be operated with AC or DC power, where the DC power may be provided by one or more batteries.

### STATEMENT REGARDING FEDERALLY SPONSORED RESEARCH OR DEVELOPMENT

(N/A)

### BACKGROUND OF THE INVENTION

The present disclosure is related generally to tooling used for piping assembly or disassembly, and relates more particularly to a heated tool to permit disassembly of piping.

Piping used in plumbing applications can be implemented in a variety of forms, typically being dependent upon the constraints or requirements of the plumbing application. One popular type of piping that has enjoyed significant acceptance for a variety of plumbing applications is PEX (cross-linked polyethylene) piping. As shown in FIG. 1, PEX piping 110 is typically a flexible tube, which is coupled to a fitting 112 to complete a piping connection. Fitting 112 can be composed of a plastic, or composed of a metal, such as brass, and PEX piping 110 is typically coupled to fitting 112 with a compression type fit.

In some implementations, the compression type fit is achieved by placing a crimp ring 114 around PEX pipe 110 over a connection section 108 of fitting 112 to which PEX pipe 110 is to be connected. In some instances, fitting 112 has a barrel-shaped section 106 that is inserted into PEX pipe 110 to form a connection. Fitting connection section 108 is generally cylindrical in shape and sized to permit PEX pipe 110 to slide over connection section 108 upon insertion to create a relatively snug fit. Connection section 108 of fitting 112 is typically ribbed with circumferentially arranged protrusions 120 that contribute to retaining PEX pipe 110 to fitting 112, once the compression type connection is made.

A mechanical connection between fitting 112 and PEX pipe 110 can be achieved by compressing PEX pipe 110 onto fitting 112 at connection section 108. The compression connection can be achieved with a crimping tool that can install crimp ring 114, which may be copper, or a cinch clamp 200 (FIG. 2), which may be stainless steel. Crimp ring 114 or cinch clamp 200 is arranged around PEX pipe 110 near an end that is joined to fitting 112. Crimp ring 114 or cinch clamp 200 is then crimped or clamped, respectively, typically with a crimping tool, around PEX pipe 110 to compress PEX pipe 110 around connection section 108 of fitting 112 to produce a fluid tight seal. FIGS. 4 and 5 illustrate fitting 112 with two sections of PEX pipe 110 being connected to connection sections 108 using crimp rings 114. Crimp rings 114 are compressed around PEX pipe 110 to force an inner surface of PEX pipe 110 to be molded to section 106 around protrusions 120, as indicated with circle 510. The compression of PEX pipe 110 onto connection section 108 generally produces a fluid tight seal that is maintained with good mechanical robustness.

PEX piping is used in a variety of applications due to its flexibility and ease of installation, as well as because of its ability to handle various type of fluids including liquids and gases that may have a relatively wide range of temperatures and pressures. Thus, PEX piping is a popular means of implementing a variety of plumbing applications in residential, commercial or industrial settings. Another appealing aspect of PEX piping is the comparative ease with which improper or incorrectly made connections can be repaired. For a given plumbing application, PEX pipe connections can sometimes be mistakenly made, so that it is desirable to undo the connection. In addition, PEX pipe connections can sometimes be made incorrectly, so that the seal between the PEX pipe and the connection section of a fitting is not fluid-tight, leading to leakage at the connection. It is desirable to undo such a connection to repair the leak, and provide a new connection that is fluid-tight.

Despite the comparative ease with regard to other piping systems, there remain several challenges to undoing a PEX pipe connection to a fitting, due to the compression-type connection established by crimping or clamping the PEX pipe to the connection section of a fitting. While in general, it is a simple matter to cut the PEX pipe at a location near an end of the connection section for the fitting, so that the PEX pipe is free of the fitting, the PEX pipe remaining on the fitting can be difficult to remove to permit the connection section of the fitting to be reused in another PEX pipe connection.

The PEX pipe connection on the fitting is typically undone by removing the crimp ring or cinch clamp installed around the PEX pipe, and then removing the PEX pipe from the connection section of the fitting. Removal of the crimp ring or cinch clamp around the PEX pipe is relatively straightforward, and can be achieved with tooling designed for that purpose. However, the PEX pipe itself, after having been subjected to the crimping or clamping action of the crimp ring or cinch clamp remains firmly secured to the fitting at the connection section of the fitting. That is, the PEX pipe portion that has been compressed onto the fitting does not slide off the connection section of the fitting as a practical matter, since a relatively high amount of force would be needed to detach the compressed PEX pipe from the connection section of the fitting. Moreover, it is impractical to cut the PEX pipe off of the fitting, such as with a sharp blade, due to the risk of damage to the fitting accompanying such a cutting operation. In general, fittings tend to be more highly valued than PEX pipe sections, so that it is generally more desirable to save a fitting than a section of PEX pipe.

The desire to save a fitting rather than a section of PEX pipe is particularly notable in the case of a manifold 300 (FIG. 3), which generally incorporates a number of fitting connections 310 for distribution of a fluid through a number of connected PEX pipe sections. If PEX pipe connections are mistakenly installed on manifold 300, it is generally preferable to cut out manifold 300 by severing the PEX pipe sections connected to manifold 300, resulting in a number of small sections of PEX pipe connected to fitting connections 310. Since a typical manifold has four or more outlets, the removed manifold installation may have four or more fitting connection sections that are unusable while the small pieces of PEX pipe remain attached to the fitting connections. Accordingly, removal of PEX pipe from a fitting connection represents a significant issue in PEX pipe plumbing applications to resolve installation problems.

One technique that is often used in the field to remove PEX pipe from a fitting connection is the application of heat from a flame torch, such as a MAP, propane or acetylene fueled flame torch. The plumbing technician applies the flame from the torch to the fitting connection, while applying a removal force to the PEX pipe, such as by pulling on a length of the PEX pipe by hand or by pulling on a PEX pipe stub with pliers. The application of the flame to the PEX pipe at the fitting connection causes the PEX pipe material to expand and permits the PEX pipe to be more easily removed from the fitting connection. The application of flame heat to the PEX pipe thus counteracts the compression engagement with the connection section of the fitting so that the PEX pipe section on the fitting connection can be removed with relative ease.

The above-described removal technique suffers from several drawbacks, including safety issues with the application of flame to PEX pipe and fittings in areas that are typically crowded or densely populated with other conduits and piping, as well as structural elements of a building. That is, plumbing applications, including those that use PEX pipe, tend to be located in areas of the building that are hidden from normal view, such as by being located in ceiling rafters, inside wall sections or under flooring, so that the plumbing does not interfere with general use of the building space. This installation practice is common for other types of conduits, including piping carrying natural gas or other fuels, air vent and exhaust duct work and electrical wiring or tubing carrying electrical wires. In addition, the building structure may be composed of or may include elements composed of flammable materials, such as wood, and other materials in the building space near the plumbing application may similarly be flammable, such as carpeting or textiles. Thus, the application of flame heat to undo a PEX pipe connection to an installed fitting represents a number of safety issues, especially since the torch flame is often applied in a specific direction in a typically crowded area, which tends to increase the likelihood of fire or damage from the torch flame. In addition, the plumbing technician applying the flame heat is more likely to suffer burns when working with torch flames or materials that are usually manipulated by hand, such as the fittings or PEX pipe in a PEX pipe installation.

Another technique for removing PEX pipe from a fitting connection is to use a heat gun that can apply a directed stream of heat at the PEX pipe connection to cause the PEX pipe to expand to permit removal from the connection section of the fitting. However, the use of a heat gun tends to be impractical in a number of instances where PEX pipe is typically installed, for some of the same reasons discussed above with respect to the difficulties of using flame heat. For example, the fittings for use with PEX pipe are typically located in crowded or difficult to access locations in a building structure, so that it can be challenging to bring a heat gun, which tends to be relatively bulky, to a position that permits enough heat to be applied to the PEX pipe to permit removal from the fitting. In addition, a heat gun may not generate the desired temperatures to remove PEX pipe connections, especially if that heat gun is not in close proximity to the PEX pipe connection.

As a result of the above-noted challenges, it is a common practice to sever the PEX pipe connections to an undesired fitting or manifold, and remove the fitting or manifold to permit installation of a new fitting or manifold in accordance with the desired plumbing application. One reason for this practice is that if a number of PEX pipe connections are to be undone, the cost for a plumbing technician to take the time to remove the unwanted PEX pipe connection can be significant, especially in comparison to the cost of the fitting, manifold or PEX pipe that is removed. Thus, it is typically much more cost effective to cut the PEX pipe and remove the fitting or manifold to permit installation of a new fitting or new manifold to overcome the unwanted PEX pipe connection configuration. It may be more practical to have a plumbing technician undo the unwanted PEX pipe connections at another time or place, such as back at a plumbing shop to recover the fittings or manifold, which can represent a cost savings in performing the plumbing installation. However, challenges remain to obtaining a safe, practical technique for easily undoing a PEX pipe connection in the field.

### BRIEF SUMMARY OF THE INVENTION

The present disclosure provides a tool for removing PEX piping from a fitting connection. The tool provides a grip for the user and a head portion that it configured to at least partially encircle a PEX pipe. The head portion includes a heat source that can apply heat to the PEX pipe to heat and expand the PEX pipe to permit removal from the fitting. The tool may be implemented to have a gripping head that permits the tool to grasp the PEX pipe while applying heat, and thus be used to apply removal force to the PEX pipe to pull the PEX pipe off of the fitting connection portion.

According to an aspect of the present disclosure, the heat source is an electrical heat source that can be adjusted to a desired temperature for heating the PEX pipe. The thermal energy generated by the heat source may be radiant heat or impingement heat, or any other type of thermally transferred energy that can be applied to a PEX pipe with the heat source of the tool. A heat source control may be provided on the tool to permit adjustment of the amount of thermal energy provided by the heat source. The control may be implemented in the form of a manual rotary knob, which can be implemented as a potentiometer, or may be implemented digitally with switches and a display to indicate the temperature of the heat source, or may be implemented in any other type of control that permits adjustment of the amount of thermal energy supplied by the heat source. The heat source may generate heat by resistive, inductive or combustion, and may provide heating in conjunction with a metal fitting, such as by induction.

According to an aspect of the present disclosure, the tool is implemented in the form of a pliers to permit the user to grip the PEX pipe and apply heat and force to the PEX pipe simultaneously. The plier grip permits the user to access the pipe connection more easily and intuitively to grasp and remove the pipe, after the application of heat from the heat source, using a single hand. According to this aspect, the tool provides a clamping opening for the head of the pliers that permits the head to be placed wholly or partially around the PEX pipe at the connection to the fitting. The head of the pliers can be implemented to form a closed loop when closed or clamped around the PEX pipe. The head may also be implemented to form a gap wide enough to accommodate a PEX pipe when the pliers are released or opened. The pliers may be implemented in the form of an adjustable pliers that provide a variable opening in the head to accommodate different size PEX pipe and associated fittings. The pliers may also include a form fitting opening in the head that permits the head to contact a majority of the circumference of the PEX pipe upon being closed on the PEX pipe. The pliers may also be implemented in multiple sizes to permit the head to accommodate different size PEX pipe and associated fittings.

According to another aspect, the tool may be implemented to have a single handle with a plier-type head that can be clamped on the PEX pipe using a ratchet or bias mechanism, such as a spring, so that the user need not apply a gripping force to the tool to permit the tool to grasp the PEX pipe for removal from the fitting.

According to an aspect, the heat source implemented in the head of the tool is electrically powered by a battery to permit the tool to be used portably. Alternately, or in addition, the tool may be powered through an inverter that draws electric power from a standard electrical outlet. The temperature range of the heat source can also be limited, so that sufficient heat can be supplied to the PEX pipe for removal, but to avoid excessive heat that might result in harm to a person inadvertently touching the heat source of the tool or the pipe or fitting being heated.

### BRIEF DESCRIPTION OF THE SEVERAL VIEWS OF THE DRAWINGS

The present disclosure is described in greater detail below, with reference to the accompanying drawings, in which:

FIG. 1 is a PEX pipe with a crimp ring and a fitting to which the PEX pipe can be connected;

FIG. 2 is a perspective view of a cinch clamp;

FIG. 3 is a perspective view of a manifold with five outlets;

FIG. 4 is a top plan view of a tee fitting with PEX pipe connections being made to two of the connection portions of the tee fitting;

FIG. 5 is a cross-sectional plan view of the fitting of FIG. 4;

FIG. 6 is a top plan view of a tool according to an exemplary embodiment of the present disclosure; and

FIG. 7 is a top plan view of a tool according to another exemplary embodiment of the present disclosure.

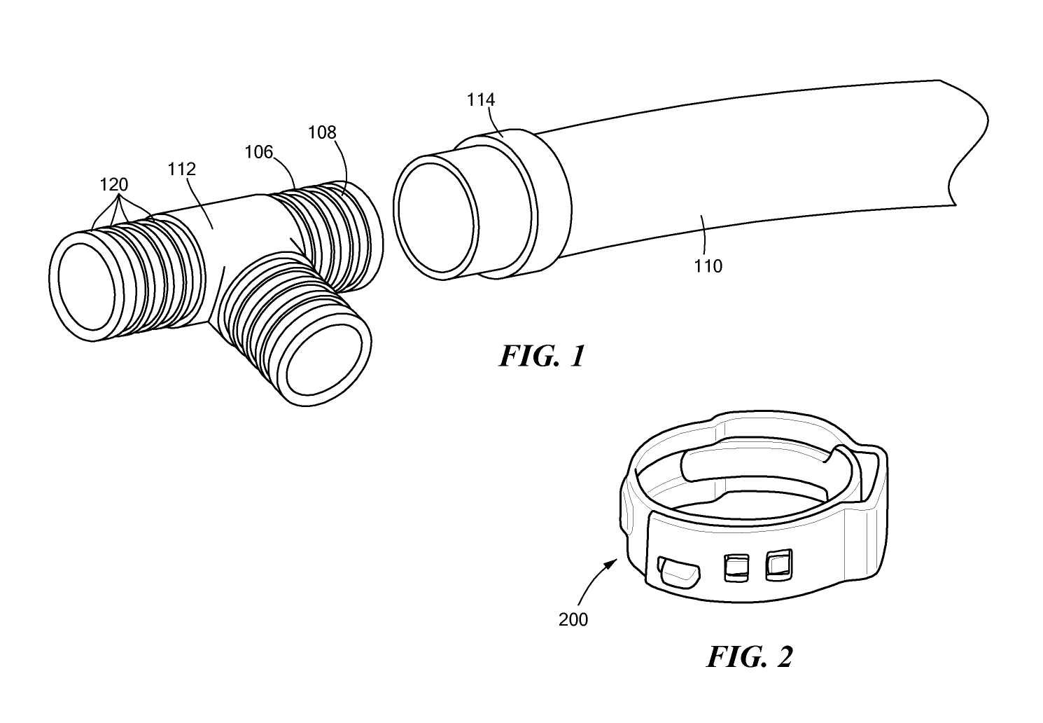

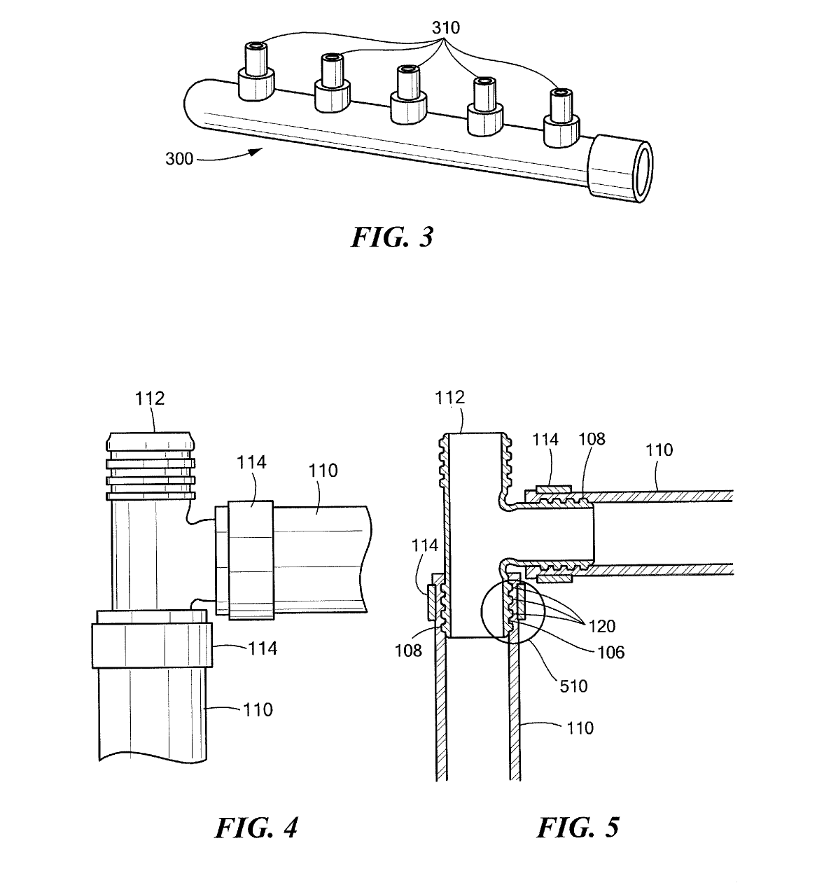

### DETAILED DESCRIPTION OF THE INVENTION

The present disclosure describes a tool for removing PEX pipe from fitting connections through the application of heat to the PEX pipe at the connection location. The tool may be implemented or configured to supply heat to the PEX pipe connection alone, or to also provide a clamp or grip on the PEX pipe to contribute to decoupling the PEX pipe from the fitting connection. An adjustment for an amount of heat provided, or a temperature setting, can be provided with the tool to permit variable heat and/or temperature application to the PEX pipe and/or fitting to permit removal of the PEX pipe from the fitting connection. The tool has a grip or handle to permit the user to hold the tool during use and avoid being exposed to higher temperature or burned.

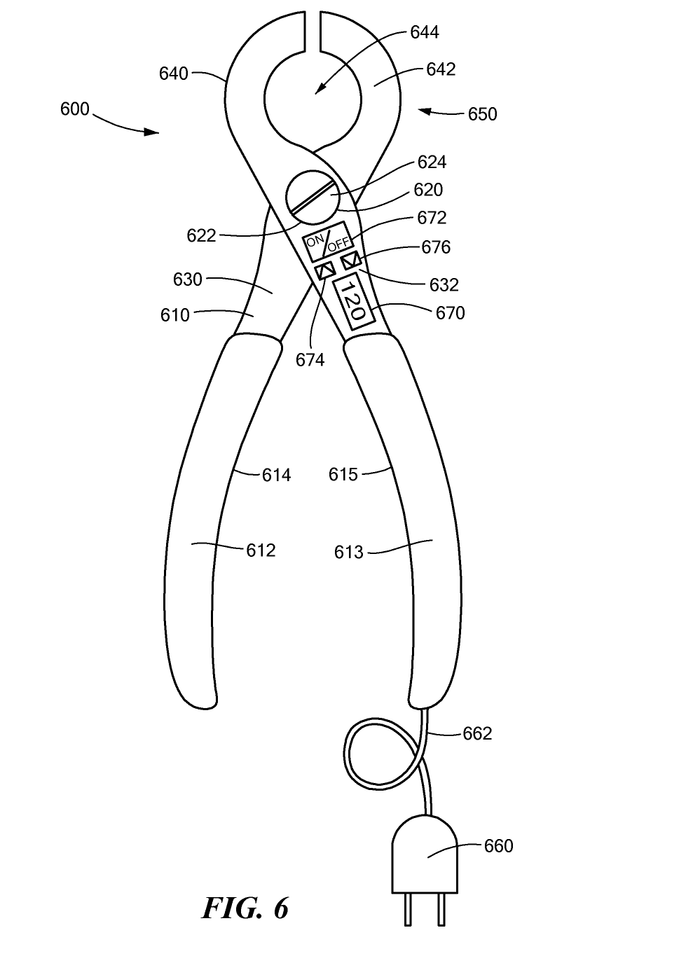

Referring now to FIG. 6, an exemplary embodiment of a tool 600 in accordance with the present disclosure is illustrated. Tool 600 is implemented as a pliers 610 that can be opened and closed under user control. Pliers 610 includes handles 612, 613 that include respective grips 614 and 615. Grips 614, 615 may be thermally insulative and may also have a relatively high friction surface material to contribute to providing a good grip for the user. Handles 612, 613 pivot about a pivot point 620, which can be implemented with a screw assembly 622. Screw assembly 622-joins a threaded screw member 624 with a cooperating screw member (not shown) on an opposite side of pliers 610. Screw assembly 622 joins together members 630 and 632 of pliers 610 while permitting members 630 and 632 to pivot about pivot point 620. When handles 612 and 613 are manipulated to be brought together or to be separated, head portions 640 and 642 are likewise brought together or separated by virtue of being located on an opposite side of pivot point 620 from handles 612, 613. Accordingly, in operation, pliers 610 permit a user to close handles 612, 613 together to bring head portions 640, 642 together in a clamping or plier action.

Head portions 640, 642 are configured to releaseably surround a PEX pipe that is positioned on a fitting to permit the application of heat to the PEX pipe. Head portions 640, 642 are shaped to form a circular opening 644 when brought together in a closed position. Circular opening 644 is configured to substantially match an outer diameter of a PEX pipe that is connected to a fitting, so as to potentially provide a number of functions. For example, a tool head 650, composed of head portion 640, 642 can be heated to act as a heat source for applying heat to a PEX pipe around which head 650 is placed. Head 650 can provide thermal energy to a PEX pipe without contacting the PEX pipe itself. In addition, or alternately, head 650 can close to contact and/or mechanically clamp PEX pipe while providing thermal energy to the pipe, and may therefore be used to pull the heated PEX pipe off of the fitting connection. In accordance with the embodiment of tool 600, head 650 may be heated entirely, or a section of the inner arcuate surfaces of head portion 640, 642 may be heated to provide thermal energy to the PEX pipe.

Tool head 650 can act as a heat source according to various modes of operation. According to one exemplary embodiment, tool head 650 can be heated by an external source, such as a torch flame, and then be used to heat a desired section of PEX pipe. Tool head 650 may also be heated with an electric heater (not shown) that may be resistive, inductive or any other type of electric heat generation mechanism. Tool 600 may house an inverter (not shown) that can accept conventional AC outlet power provided through a plug 660 and cord 662. The inverter converts the input AC power to DC power, which is used to supply electric power to the heat generation mechanism to produce thermal energy in tool head 650.

According to an exemplary embodiment, the electric heat generation is controlled using various user controls and temperature feedback devices. For example, tool head 650 may include a thermocouple (not shown) that provides a feedback signal that can be used to determine and indicate a temperature of tool head 650. A display 670 may be provided on handle 613, for example, to indicate a temperature value for tool head 650. Display 670 can be driven by the feedback signal provided by a thermocouple in accordance with well known and conventional techniques.

According to an exemplary embodiment, an on/off switch 672 can be provided to turn the heater mechanism on or off, and a temperature up/down control can be implemented using a temperature increase button 674 and a temperature decrease button 676. Temperature increase/decrease buttons 674, 676 may be used to adjust the heat output of tool head 650 to generate a desired amount of heat for removal of PEX pipe. According to another exemplary embodiment, not shown in the figures, a temperature control, such as may be implemented with on/off switch 672, increase/decrease buttons 674, 676 and display 670, may be located externally to tool 600, such as by being placed in line with cord 662 to permit simplified manufacture of tool 600 and/or the advantages of modularization.

The operation of tool 600 can begin with the generation of heat at tool head 650. Such heat generation may be implemented with external heat sources, such as a torch flame, or may be electrically generated using the heat generation mechanism of tool 600, described above. Alternately, or in addition, tool head 650 can be positioned around the PEX pipe prior to or while being heated. Tool head 650 is heated to a desired temperature, which may be any temperature in the range of 0-500° F., or more particularly, in a range of 100-150° C., which range or temperature specification may depend upon the PEX pipe application. Once tool head 650 is heated to a desired temperature, handles 612, 613 are separated to open head 650 and separate head portions 640, 642. Head 650 is then placed around the PEX pipe section that is connected to the fitting to heat the PEX pipe section that forms the connection with the fitting. Handles 612, 613 are then closed or brought together, such as by squeezing by hand, thereby closing or bringing together head portion 640, 642. With this action, circular opening 644 decreases in size to bring head portions 640, 642 into close proximity, or into contact with, the desired section of PEX pipe, thereby applying heat to the desired pipe section.

Once the PEX pipe section is heated, the pipe can be removed by manually pulling on the PEX pipe to cause the PEX pipe to slide off the fitting connection, or the inner surfaces of circular opening 644 can contact and grasp the desired PEX pipe section, so that the user can pull the PEX pipe off of the fitting connection by manually pulling tool 600 away from the fitting when in the closed position. Once the PEX pipe is removed from the fitting, tool 600 can be opened by driving handles 612, 613 apart to open tool head 650 by separating head sections 640, 642. According to an exemplary embodiment, tool 600 may be provided with a spring or other resilient mechanism to contribute to driving handles 612, 613 apart to open tool 600, thereby potentially improving the utility of the tool. The process of applying tool 600 to a PEX pipe connection may be repeated any number of times, without necessarily adjusting the temperature of tool head 650. Once the desired PEX pipe has been successfully removed from the desired fitting(s) the heat mechanism of tool 600 can be turned off through actuation of on/off button 672, or by unplugging plug 660 from the power outlet. Alternately, or in addition, the control for the heater mechanism may include a timeout timer that turns off the heat mechanism when the tool is not in use for some period of time.

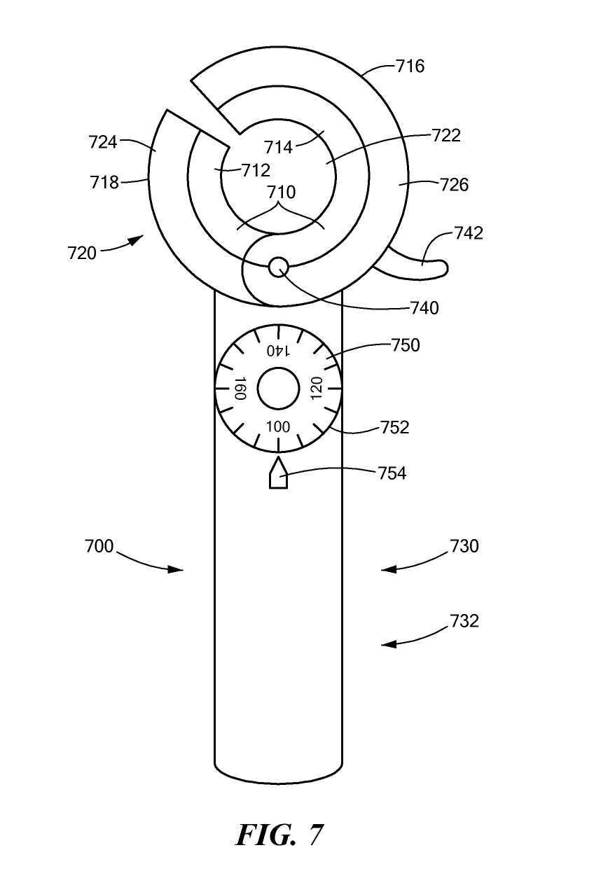

Referring now to FIG. 7, another exemplary embodiment of a tool 700 in accordance with the present disclosure is illustrated. Tool 700 provides a generally circular heat source 710 that can be placed around PEX pipe to heat the pipe for removal from a fitting connection. Tool 700 includes a head portion 720 and a grip or handle portion 730. Head portion 720 includes heat source 710, which is disposed in two different sections, a fixed section 712 and a pivoting section 714. Fixed section 712 and pivoting section 714 are each electrically connected to an electrical power source, and are capable of converting electric power to thermal energy. Thus, heat source 710 can provide heat through conversion of electric energy to thermal energy in accordance with various techniques, including resistive, inductive, or any other type of heating element that is driven with electric power.

Head section 720 is illustrated with heat source 710 being exposed to lateral sides of tool 700. However, heat source 710 can be shielded on lateral sides with thermally insulative material, so that heat source 710 delivers thermal energy along an inner circumference of generally cylindrical opening 722. According to such an embodiment, a user is provided with greater protection from exposure to the relatively high heat generated by heat source 710.

In the exemplary embodiment illustrated in FIG. 7, head section 720 includes a fixed thermally insulative member 724 and a pivoting thermally insulative member 726. Members 724 and 726 are generally shaped as circular or arcuate portions and surround adjacent fixed and pivoting sections 712, 714, respectively. Members 724 and 726 provide a measure of protection to the user from the relatively high temperatures generated by heat source 710. Fixed section 712 is aligned with member 724 in an arcuate shape to permit member 724 to act as a thermal shield for fixed section 712. While fixed section 712 and member 724 are fixed in location with respect to handle section 730, pivoting section 714 and member 726 are pivotable above a point 740, while being adjacent to each other so that member 726 acts as a thermal shield for pivoting section 714. Pivoting section 714 and member 726 are generally circular, arcuate sections that abut with, and may be affixed to, each other.

Head portion 720 further includes a finger tab 742 that is attached to member 726 of head portion 720. Tab 742 can be pressed by the user to open head portion 720 by pivoting a section 716 of head portion 720 about a pivot point 740. Pivot point 740 may be implemented as a rivet, screw, post, or any other type of element that permits section 716 to pivot in a relation to a fixed section 718. Section 716 may include a resilient member (not shown), such as a spring, that generally biases section 716 into a closed position, so that actuating tab 742 opens head portion 720 against a bias. By actuating tab 742, the user can open head portion 720 and permit placement of tool 700 around a PEX pipe, so that releasing tab 742 permits section 716 to pivot with a bias, for example, to surround a PEX Pipe in opening 722. With the PEX Pipe occupying opening 722, tool 700 permits thermal coupling between heat source 710 and the PEX pipe.

Head section 720 may also be used to mechanically grip the PEX pipe to assist in removing the PEX pipe from a fitting connection. When pivoting section 716 is biased into a closed position, the inner circumferential surface of heat source 710 can contact and grip the PEX pipe to permit tool 700 to assist with pulling the PEX pipe off of the fitting connection. In addition, tool 700 can be used to apply heat to the PEX pipe for manual removal by the user pulling the PEX pipe off of the fitting connection by pulling on a length of the PEX pipe away from the fitting connection. In accordance with the optional function of a mechanical assist and removal of the PEX pipe from the fitting connection, tool 700 includes a grip area 732 in handle section 730 to permit a user to grasp grip area 732 to contribute to pulling the PEX pipe off of the fitting connection.

Handle section 730 includes a temperature control 750 that provides an adjustable control mechanism for controlling the temperature of heat source 710. Control 750 includes a rotatable wheel 752 that is marked with temperature gradations. The user can adjust the temperature control by rotating wheel 752 to align a desired temperature gradation with pointer 754. Wheel 752 may be connected to an electrical component that permits adjustment of the parameters of the electric power supplied to heat source 710 to control the temperature generated by heat source 710. For example, wheel 752 may be connected to a potentiometer (not shown) that can adjust the resistance in a circuit that includes heat source 710 to control the amount of electric power received by heat source 710. Such a potentiometer may be arranged in a bridge-type circuit to provide relatively precise or consistent control of heat source 710. Alternately, or in addition, circuitry may be provided within handle section 730 that forms a control circuit for modulating the electric power supply to heat source 710, using a rotation of wheel 752 as an input signal. In this way, a digital or analog control circuit may be provided to control the temperature output of heat source 710 using adjustments of wheel 752, which may be implemented as a rotational encoder, for example. Optionally, an indicator light (not shown) may be provided on handle section 730 to indicate when tool 700 is in operation and supplying heat from heat source 710. The heat control system provided in tool 700 to control the temperature output of heat source 710 may be open loop, with adjustments of wheel 752 being calibrated to temperature values output by heat source 710 in a factory environment. Alternately, or in addition, a feedback may be used to more precisely control the temperature of heat source 710, such as by employing a thermocouple (not shown) that obtains a voltage signal correlated to the temperature of heat source 710. The voltage signal from such a thermocouple can be fed back to a control circuit housed in handle section 730 to contribute to more accurately modulating a temperature of a heat output of heat source 710.

Tool 700 may employ various types of power sources, including battery power or utility power typically obtained from a wall socket outlet. Handle section 730 can be provided with a battery chamber (not shown) that can house batteries used to generate the electrical power that is used by heat source 710 to generate a thermal output. According to an exemplary embodiment, tool 700 may include a DC-DC converter that can step up or step down battery voltage to a desired level for generating a DC electrical input to heat source 710 to generate the desired thermal output. Alternately, or in addition, tool 700 may be provided with an inverter used to convert AC utility power to a DC power signal that may likewise be applied to heat source 710 to generate a thermal output. The same inverter output may also be used to charge batteries that are housed within the battery chamber of handle section 730. In such an instance, handle 730 may be provided with a switch (not shown) used to turn tool 700 off to permit the batteries to be recharged without obtaining a thermal output from heat source 710. Wheel 752 may also be implemented to have a setting that causes heat source 710 to be switched off to permit batteries housed in handle section 730 to be recharged. By providing tool 700 with capability of operating under battery power, and the option of recharging the batteries, tool 700 can be used portably at job sites that may potentially lack sufficient utility power connections, thus potentially improving the utility and productivity of tool 700.

While the embodiments illustrated in FIGS. 6 and 7 show pivoting head portions that can close around a PEX pipe, other mechanical arrangements are readily available. Such arrangements may, for example, include a ratchet, spring loaded or clamping slide to bring the head portions together, or a screw driven mechanism, such as is often used with a pipe wrench. In addition, while the illustrated embodiments show concavely shaped surfaces that are brought into proximity or contact with the PEX pipe, the surfaces that interact with the PEX pipe need not all be concave. Furthermore, the heating element used to heat the PEX pipe need not surround the PEX pipe in use, but can be arranged to heat a partial circumference of the PEX pipe.

The foregoing description has been directed to particular embodiments of the present disclosure. It should be apparent that other variations and modifications may be made to the described embodiments, with the attainment of some or all of their advantages. Accordingly, it is the object of the appended claims to cover all such variations and modifications in the true spirit and scope of the present disclosure.

1. A tool for removing PEX pipe from a fitting, comprising:
a first handle for a user to grasp the tool;
a first head portion rigidly coupled to the first handle;
a second head portion mechanically coupled to the first head portion to permit relative movement with respect to the first head portion;
the first head portion or the second head portion being provided with a thermal element that includes a concavely curved surface for receiving the PEX pipe;
a thermal element driver coupled to the thermal element and operative to provide energy to the thermal element to heat the thermal element to a sustained temperature in a range of from about 100° C. to about 150° C.; and
an actuator mechanically coupled to the second head portion to cause the second head portion to move toward or away from the first head portion upon actuation;
wherein the tool is operative to be held by the first handle by a user to place the first head portion and the second head portion at least partially around the PEX pipe using the actuator and operative to drive the thermal element driver to heat the thermal element to a sustained temperature in the range using the thermal driver to permit the PEX pipe to be heated and removed from the fitting.

2. The tool according to claim 1, wherein the second head portion is pivotally connected to the first head portion to permit pivotal movement with respect to the first head portion.

3. The tool according to claim 1, further comprising an electric power source being electrically coupled to the thermal element driver to provide electric power to the thermal element driver.

4. The tool according to claim 3, wherein the thermal element further comprises a heating element being operable to receive the electric power from the thermal element driver to generate heat energy.

5. The tool according to claim 4, further comprising a controller coupled to the electric power source and being operable to control an amount of the electric power that is provided to the heating element.

6. The tool according to claim 3, wherein the electric power source is a power converter circuit being configured to accept DC or AC input electrical power.

7. The tool according to claim 5, wherein the controller further comprises an actuator that can accept input from a user to modulate the controller to control the amount of the electric power that is provided to the heating element.

8. The tool according to claim 1, wherein the thermal element is operable to output thermal energy via one or more of resistive heating, inductive heating or combustion heating.

9. The tool according to claim 1, further comprising a second thermal element on another of the first head portion or the second head portion, the second thermal element being operable to output thermal energy for heating the PEX pipe.

10. The tool according to claim 1, wherein the actuator further comprises a second handle connected to the second head portion and being cooperatively operable with the first handle to cause the second head portion to move toward or away from the first head portion.

11. The tool according to claim 10, wherein the tool is implemented as pliers.

12. The tool according to claim 5, further comprising a thermal transducer being thermally coupled to the heating element and being operable to provide an electrical output in relation to the thermal output of the heating element.

13. The tool according to claim 12, wherein the heat transducer further comprises a thermocouple with an output that is electrically coupled to the controller to provide a feedback signal for controlling a temperature of the heating element.

14. The tool according to claim 1, further comprising a resilient member coupled to the second head portion to bias the second head portion toward the first head portion.

15. The tool according to claim 1, further comprising a ratchet mechanism coupled to the second head portion and being operable to urge the second head portion toward the first head portion with discrete levels of urging force.

16. A method for removing a PEX pipe from a fitting connection, comprising:
providing an electrically driven heat source with a concave surface;
placing the concave surface of the heat source in proximity to the PEX pipe;
heating the PEX pipe to a sustained temperature in a range of from about 100° C. to about 150° C.; and
applying an urging force to the heated PEX pipe to urge the heated PEX pipe away from the fitting connection.

17. The method according to claim 16, further comprising:
urging the heat source in contact with the PEX pipe to permit the PEX pipe to be simultaneously heated and clamped; and
urging the heat source away from the fitting connection while being clamped to the heated PEX pipe to urge the heated PEX pipe away from the fitting connection.

18. The tool according to claim 1, wherein the thermal element is at least partially shielded from access outside of the concavely curved surface.

19. (canceled)

20. A method for removing PEX pipe from a fitting connection, comprising:
providing a tool for heating the PEX pipe, including:
providing a first handle for a user to grasp the tool;
rigidly coupling a first head portion to the first handle;
mechanically coupling a second head portion to the first head portion to permit relative movement with respect to the first head portion;
providing a thermal element to one or more of the first head portion or the second head portion, the thermal element including a concavely curved surface for receiving the PEX pipe;
electrically coupling a thermal element driver to the thermal element to control energy provided to the thermal element to heat the thermal element to a sustained temperature in a range of from about 100° C. to about 150° C.; and
mechanically coupling an actuator to the second head portion to cause the second head portion to move toward or away from the first head portion upon actuation;
connecting an electric power source to the thermal element driver;
locating the first and the second head portions proximate to the PEX pipe and actuating the actuator to cause the second head portion to move toward the first head portion without contacting the fitting;
actuating the thermal element driver to provide electrical energy to the thermal element to heat the thermal element and to a sustained temperature in a range of from about 100° C. to about 150° C. thus heating the PEX pipe to loosen the PEX pipe from the fitting connection; and
urging the heated PEX pipe off of the fitting connection.
